(19) United States
(12) Patent Application Publication
(10) Pub. No.: US 2008/0163258 A1
(43) Pub. Date: Jul. 3, 2008

(54) NOTIFICATION OF STATE TRANSITION OF AN OUT-OF-FOCUS APPLICATION WITH NOTIFICATION PRECEDENCE

(76) Inventor: Swaminathan Balasubramanian, Sterling Heights, MI (US)

Correspondence Address: SCHMEISER, OLSEN & WATTS, 22 CENTURY HILL DRIVE, SUITE 302, LATHAM, NY, 12110, US

(21) Appl. No.: 12/040,012

(22) Filed: Feb. 29, 2008

Related U.S. Application Data
(63) Continuation-in-part of application No. 11/756,700, filed on Jun. 1, 2007.
Application No. 11/756,700 is a continuation-in-part of application No. 11/505,131, filed on Aug. 15, 2006.

(51) Int. Cl. G06F 13/00

(52) U.S. Cl. 719/318

(57) ABSTRACT

A method, a computer program product, a computer system and a method for supporting an application. The method includes: starting multiple applications, each application having multiple possible states and having state transitions between the possible states; starting and displaying each application in respective display modes on a computer screen; assigning a notification priority from a list of notification priorities to each state transition of each application, each notification priority determining a display mode; selecting notification priorities, for each selected notification priority, assigning a precedence order from high to low to those applications having a same selected notification priority; and upon state transitions of applications resulting in two or more applications being in a same notification priority, displaying on the computer screen, in a display mode associated with the same notification priority, only that application of the two or more applications having a higher precedence order.

This application is a Continuation-In-Part of copending application Ser. No. 11/756,700 filed on Jun. 1, 2007, which is a Continuation-In-Part of copending application Ser. No. 11/505,131 filed on Aug. 15, 2006.

### FIELD OF THE INVENTION

The present invention relates to the field of computer software; more specifically, it relates to method for notification of a user of a state transition of an out-of-focus software application.

### BACKGROUND OF THE INVENTION

The widespread availability of high performance computers has enabled users to run multiple applications simultaneously on their workstations. This has resulted in applications competing for user attention and interruptions of applications the user is currently interfacing with. Furthermore, there is no uniform methodology for applications to obtain the user's attention. Users are thus subject to interruptions and productivity is adversely affected when an application is idle and waiting for user attention or the user is forced to transfer their attention to another application.

Therefore, there is a need for a method for applications to notify the user of an applications status and need for attention without interrupting the user and the application the user is currently working with

### SUMMARY OF THE INVENTION

A first aspect of the present invention is a method, comprising: starting multiple applications, each application of the multiple applications having multiple possible states and having state transitions between the possible states; starting and displaying each application of the multiple application in respective display modes on a computer screen; assigning a notification priority from a list of notification priorities to each state transition of each application of the multiple applications, each notification priority determining a display mode; selecting notification priorities from the list of notification priorities; for each selected notification priority, assigning a precedence order from high to low to those applications of the multiple applications having a same selected notification priority; and upon state transitions of applications of the multiple applications resulting in two or more applications of the multiple applications being in a same notification priority, displaying on the computer screen, in a display mode associated with the same notification priority, only that application of the two or more applications having a higher precedence order.

A second aspect of the present invention is a computer program product, comprising a computer useable medium having a computer readable program therein, wherein the computer readable program when executed on a computer causes the computer to perform the method of: starting multiple applications, each application of the multiple applications having multiple possible states and having state transitions between the possible states; starting and displaying each application of the multiple application in respective display modes on a computer screen; assigning a notification priority from a list of notification priorities to each state transition of each application of the multiple applications, each notification priority determining a display mode; selecting notification priorities from the list of notification priorities; for each selected notification priority, assigning a precedence order from high to low to those applications of the multiple applications having a same selected notification priority; and upon state transitions of applications of the multiple applications resulting in two or more applications of the multiple applications being in a same notification priority, displaying on the computer screen, in a display mode associated with the same notification priority, only that application of the two or more applications having a higher precedence order.

A third aspect of the present invention is a computer system comprising a processor, an address/data bus coupled to the processor, and a computer-readable memory unit coupled to communicate with the processor, the memory unit containing instructions that when executed implement a method for dynamically notifying a user of a change in state of an application running on the computer system, the method comprising the computer implemented steps of: starting multiple applications, each application of the multiple applications having multiple possible states and having state transitions between the possible states; starting and displaying each application of the multiple application in respective display modes on a computer screen; assigning a notification priority from a list of notification priorities to each state transition of each application of the multiple applications, each notification priority determining a display mode; selecting notification priorities from the list of notification priorities; for each selected notification priority, assigning a precedence order from high to low to those applications of the multiple applications having a same selected notification priority; and upon state transitions of applications of the multiple applications resulting in two or more applications of the multiple applications being in a same notification priority, displaying on the computer screen, in a display mode associated with the same notification priority, only that application of the two or more applications having a higher precedence order.

A fourth aspect of the present invention is a process for supporting computer infrastructure, the process comprising providing at least one support service for at least one of creating, integrating, hosting, maintaining, and deploying computer-readable code in a computing system, wherein the code in combination with the computing system is capable of performing a method for notification priority with precedence, the method comprising: starting multiple applications, each application of the multiple applications having multiple possible states and having state transitions between the possible states; starting and displaying each application of the multiple application in respective display modes on a computer screen; assigning a notification priority from a list of notification priorities to each state transition of each application of the multiple applications, each notification priority determining a display mode; selecting notification priorities from the list of notification priorities; for each selected notification priority, assigning a precedence order from high to low to those applications of the multiple applications having a same notification priority; and upon state transitions of applications of the multiple applications resulting in two or more applications of the multiple applications being in a same notification priority, displaying on the computer screen, in a display mode associated with the same notification priority, only that application of the two or more applications having a higher precedence order.

### BRIEF DESCRIPTION OF DRAWINGS

The features of the invention are set forth in the appended claims. The invention itself, however, will be best understood by reference to the following detailed description of an illustrative embodiment when read in conjunction with the accompanying drawings, wherein:

FIG. 1 is a schematic drawing of a user desktop illustrating an in-focus application and an out-of-focus application running simultaneously according to embodiments of the present invention;

FIG. 2 is a schematic drawing of a user desktop illustrating the out-of-focus application indicating normal activity according to embodiments of the present invention;

FIG. 3 is a schematic drawing of a user desktop illustrating the out-of-focus application indicating user response required according to embodiments of the present invention;

FIG. 4 is a schematic drawing of a user desktop illustrating the out-of-focus application indicating an error has occurred according to embodiments of the present invention;

FIG. 5 is a schematic drawing of a user desktop after a user response to an error message of the out-of-focus application according to embodiments of the present invention;

FIG. 6 is a schematic drawing of an alternative user desktop after a user response to an error message of the out-of-focus application according to embodiments of the present invention;

FIGS. 7A and 7B are flowcharts illustrating the method of user notification of a state transition of an out-of-focus application according to embodiments of the present invention;

FIG. 8 is a system diagram for implementing the method of user notification of a state transition of an out-of-focus application according to embodiments of the present invention;

FIG. 9 is a schematic block diagram of a general-purpose computer for practicing the embodiments of the present invention;

FIG. 10 is a system diagram for implementing the method of user notification of a state transition of an out-of-focus application according to further embodiments of the present invention;

FIG. 11A is a schematic diagram of a portion of an application according to embodiments of the present invention;

FIG. 11B is a detailed diagram of the state transition registry of FIG. 10;

FIGS. 12A and 12B flowcharts illustrating the method of user notification of a state transition of an out-of-focus application according to further embodiments of the present invention;

FIG. 13 illustrates state transition diagrams for exemplary applications X, Y and Z having common notifications priorities according to embodiments of the present invention;

FIG. 14 is a flowchart illustrating a method of priority notification precedence according to embodiments of the present invention; and

FIG. 15 is a system diagram for implementing the method of user notification precedence of a state transition of an out-of-focus application according to further embodiments of the and for application state and notification priority filtering according to embodiments of present invention.

### DETAILED DESCRIPTION OF THE INVENTION

A window is defined as a visual area containing a user interface displaying the output of and allowing input to a number of simultaneously running computer processes. A control widget is defined as means that a computer user interacts with in order to control and interface component such as a window or a text box. Control widgets come in two forms, virtual and physical. A button is an example of a control widget. A virtual button can be clicked with a mouse cursor while a physical button can be pressed with a finger.

In computing, the focus is the component of the graphical user interface, which is currently selected. Text entered at a keyboard or pasted from a clipboard is sent to the application, which currently has the focus. Graphical user interfaces also use a mouse cursor. Moving the mouse will typically move the mouse cursor over the screen and windows displayed on the screen without changing the focus. In a Microsoft™ windows system or an Apple™ computer, the focus can be changed by clicking on a component that can receive focus with the mouse. Clicking a mouse button when the mouse cursor is over a window selects the window to be in-focus. This is called a “focus follows click “policy or “click to focus”. Focus may also be changed using the keyboard. In a UNIX computer system, the “focus follows the mouse cursor” policy is used.

An in-focus application is defined as a running application that has been selected by a control widget and to which any user input will be directed. For example, placing a cursor over a window and clicking a mouse button will put the application running in the window in focus and keyboard strokes will be inputted into the in-focus application. An out-of-focus application is a running application to which user input is not directed. For example, any keyboard strokes will be not be inputted into the out-of-focus application. Alternatively, an out-of-focus application can be defined as an application that is not in focus.

When multiple applications are running (running includes time when the application is idle, i.e., the application is loaded into memory but not processing), one application is considered “in-focus” and the others are considered “out-of-focus”. Idle applications can receive input, but only when they are in-focus. Control widgets within windows may require a further click to focus them, to differentiate the different places input may go.

Examples of applications include, but are not limited to, word processors, spread sheets, computer aided design (CAD) programs, audio, picture and video editing programs, communication programs, email programs web browsers and various utility programs.

In certain operating systems, such as Microsoft™ Windows, the computer screen displays a desktop, which may include application desktop icons (control widgets) and a task bar (control widget). In the task bar a task button (control widget) is displayed for each running application. The task button includes a task button icon and a title. In-focus and out-of-focus applications may also appear in windows displayed on the desktop. The in-focus application is indicated by a highlighted task button and/or highlighted window associated with the in-focus application. A title-bar appears at the top of the window. The exit, minimize and restore/maximize buttons found in the upper right hand corner of the title bar are control widgets.

There are several types of special windows in a graphical user interface in addition to the application/document window displaying the application. One type of special window is a dialog box. In a dialog box appears when communication is requested or required outside the applications normal workflow between the application or operating system and the user. A dialog box is another type of widget. In non-model or modeless dialog box focus is not changed when it appears. In a modal dialog box, focus is changed to the dialog box.

The embodiments of the present invention will be described in the context of a windows-like operating system that utilizes a task bar, but is applicable to other types of operating systems such as UNIX, which do not use a task bar, but do display icons on the desktop. In the case of such operating systems, the features of the present invention are applied to the desktop icon instead of the task button icon. Alternatively, for applications that do use a desktop icons and task bar task button icons, icon overlays may be applied to both the desktop icons and the task button icons.

In one example, the present invention modifies the task button icons by adding an icon overlay to the task button icon. The icon overlay indicates the state of the application and changes when the application changes state (transitions between states) in order to dynamically notify the user of a change in state of the applications without forcing itself on the user. Icon overlays may be applied to only out-of-focus applications or both in-focus and out-of-focus applications.

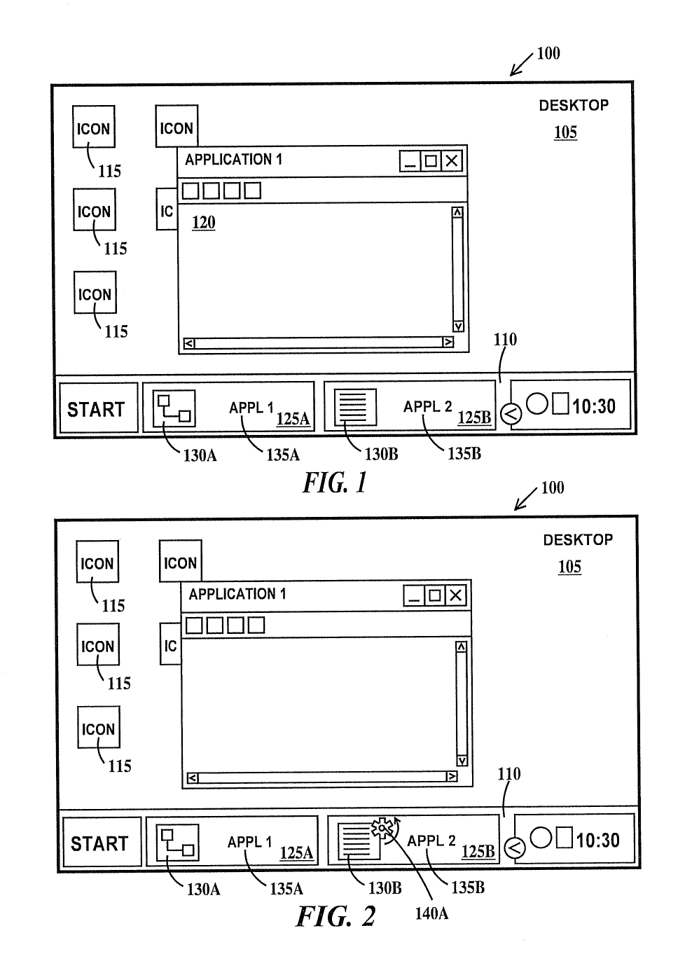

FIG. 1 is a schematic drawing of a user desktop illustrating an in-focus application and an out-of-focus application running simultaneously according to embodiments of the present invention. In FIG. 1, a desktop 100 (displayed on a computer screen) includes a workspace region 105 and a task bar region 110. Displayed in workspace region are icons 115 for various applications and a window 120 displaying an in-focus application. Task bar region 110 includes a first task button 125A and a second task button 125B. First task button 125A includes a task button icon 130A and a title 135A (APPL 1). Second task button 125B includes a task button icon 130B and a title 135B (APPL 2). First task button 125A is associated with a first application running in window 120. Second task button 125B is associated with a second out-of-focus application. Task button icon 130B is the standard task button icon for the second application. The absence of an overlay icon indicates the second application is loaded but is in a state that does not require user notification (for example, idle).

FIG. 2 is a schematic drawing of a user desktop illustrating the out-of-focus application indicating normal activity according to embodiments of the present invention. In FIG. 2, the second application has changed state and is now running. To inform the user of the new status of the second application an overlay icon 140A is imposed over standard icon 130B. Overlay icon 140A may be animated. In the example of FIG. 2, overlay icon 140A is a spinning gear. Alternatively, standard icon 130B is replaced with a whole new icon that includes the overlay icon 140A graphics.

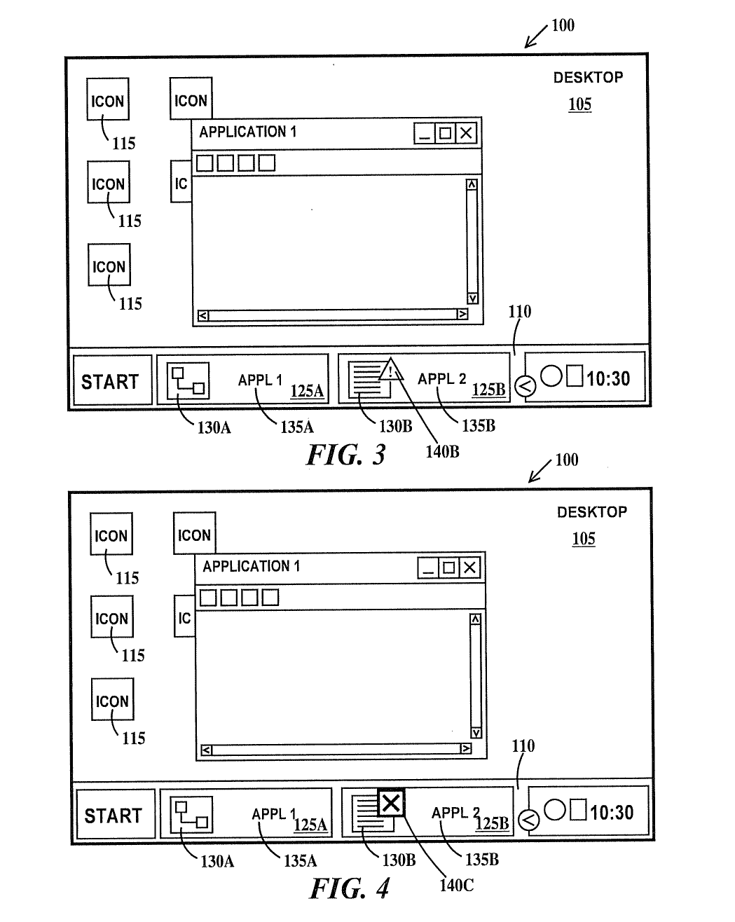

FIG. 3 is a schematic drawing of a user desktop illustrating the out-of-focus application indicating user response required according to embodiments of the present invention. In FIG. 3, the second application has again changed to a new state where processing has been stopped because user input is required. To inform the user of the new status of the second application (i.e., processing stopped because input is required) an overlay icon 140B is imposed over standard icon 130B. In the example of FIG. 3, overlay icon 140B is triangle with an exclamation point. In one example, the color of overlay icon may be selected to enhance the visual clue given by the presence of the overlay icon graphics. For example, overlay icon 140B may have a yellow background. In one example, an audio clue may be associated with overlay icon 140B. Combinations of animation, audio and color clues may be used together. Alternatively, standard icon 130B (see FIG. 1) is replaced with a whole new icon that includes the overlay icon 140B graphics. The out-of-focus application remains out-of-focus until the user presses second task button 125B, which will bring the second application up in a window so the user may supply the required input.

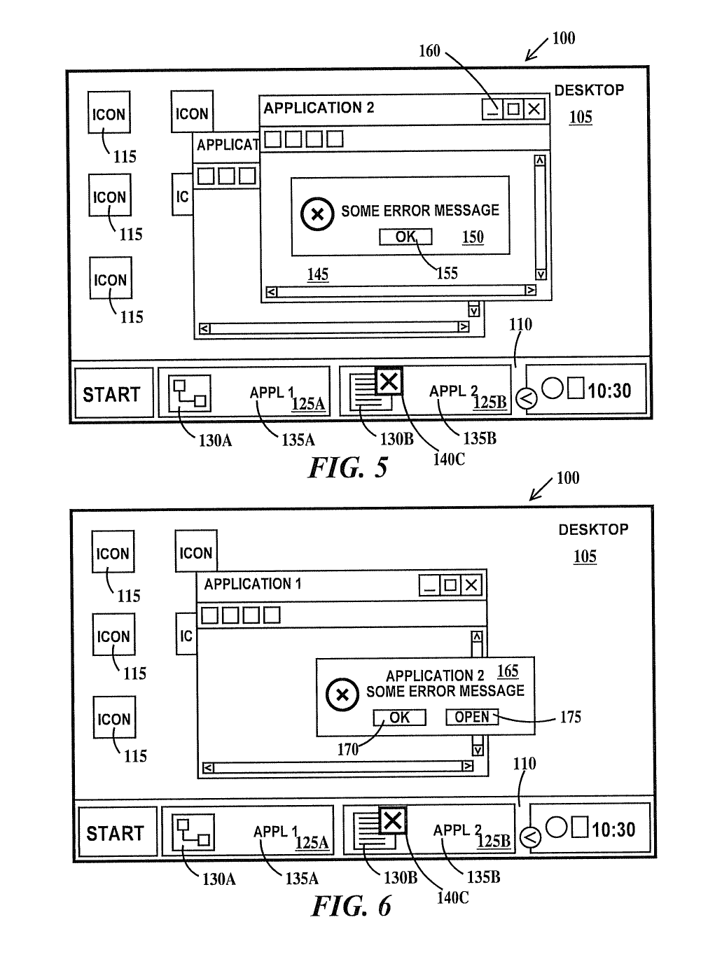

FIG. 4 is a schematic drawing of a user desktop illustrating the out-of-focus application indicating an error has occurred according to embodiments of the present invention. In FIG. 4, the second application has again changed state where processing has been stopped because of an error. To inform the user of the new status of the second application (i.e., processing has stopped because an error has occurred) an overlay icon 140C is imposed over standard icon 130B. In one example, overlay icon 140C is animated. In the example of FIG. 4, overlay icon 140B is square with an X. In one example, the color of overlay icon may be selected to enhance the visual clue given by the presence of the overlay icon graphics. For example, overlay icon 140C may have a red background. In one example, an audio clue may be associated with overlay icon 140C. Combinations of animation, audio and color clues may be used together. Alternatively, standard icon 130B (see FIG. 1) is replaced with a whole new icon that includes the overlay icon 140B graphics. The out-of-focus application remains out-of-focus until the user the user presses second task button 125B, which will allow the user to respond to the error. There are two different actions possible as illustrated in FIGS. 5 and 6 and described infra.

FIG. 5 is a schematic drawing of a user desktop after a user response to an error message of the out-of-focus application according to embodiments of the present invention. In FIG. 5, the user has “pressed” task button 125B in response to the error clue and a window 145 for the second application has opened on desktop 105, bringing the second application into focus. Additionally, an error message window 150 has opened giving information about the error. After pressing an OK button 155, error message window 150 will close leaving window 145 open (the application will be in-focus) and the user may correct the error. The user may then close window 145 by pressing a minimize task button 160 returning the second application to out-of-focus operation.

FIG. 6 is a schematic drawing of an alternative user desktop after a user response to an error message of the out-of-focus application according to embodiments of the present invention. In FIG. 6, the user has “pressed” task button 125B in response to the error clue and error message window 165 giving information about the error for the second application has opened on desktop 105. However, the second application is still out-of-focus. If the user “presses” an OK button 170, error window 165 will close, the second application will remain out-of-focus and overlay icon 140C is still present. If the user “presses” an OPEN button 175, error message window 165 will close and a window similar to window 145 of FIG. 5 will open. The application will be in-focus and the user may correct the error. The user may then close this window by pressing a minimize task button returning the second application to out-of-focus mode. This alternative behavior of the application allows the user to determine when to deal with the error without changing the focus of any application.

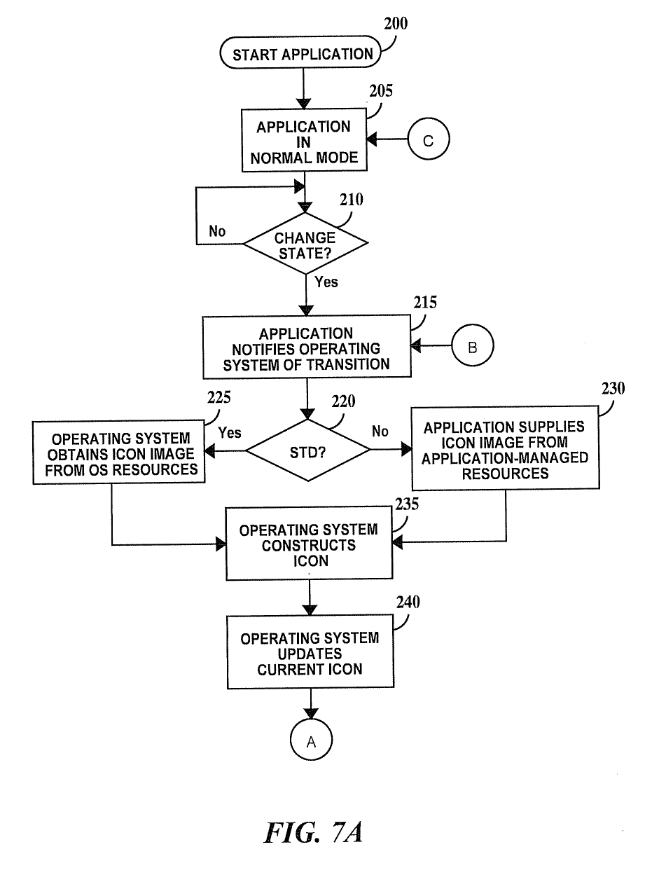

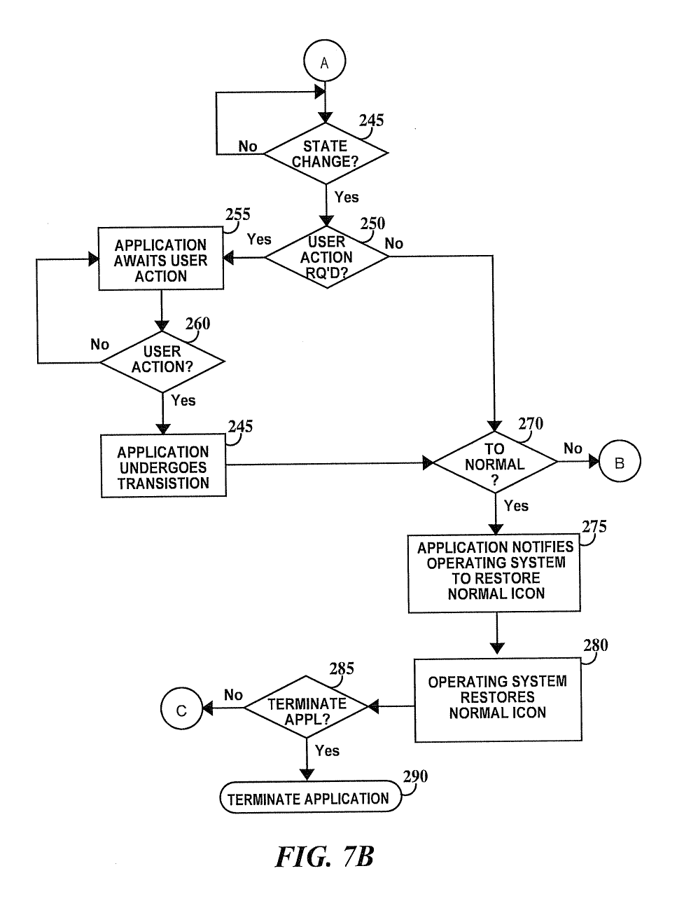

FIGS. 7A and 7B are flowcharts illustrating the method of user notification of a state transition of an out-of-focus application according to embodiments of the present invention. In step 200 the user starts an application. Alternatively, the application is started by the operating system (OS) at boot-up, at a predetermined time or day, or by another application. In step 205, the application is initialized to a normal state (i.e. idle), the application minimized (placed in out-of-focus mode) by the user, OS, or another application and a normal icon placed in the task button. In step 210, the application continually monitors itself for a change in state until a change in state occurs and the method proceeds to step 215. Examples of changes of state include but are not limited to, transitions from an idle state to processing state and vice versa, from a processing state to a input required state and vice versa, from the processing state to an error state and vice versa, and from one processing state to another processing state. A processing state is a state where the program is performing a normal task, such as a calculation, a search, downloading/uploading from/to a server, retrieving/storing information and other tasks the application was designed to perform.

In step 215, the application notifies the OS of a change in state. In step 220 it is determined if the transition is to a standard state. A standard state is a state that the application enters that has the same semantics across different applications. (for example, an error state or a user input required state). If the transition is a to a standard state, then in step 225, the OS obtains an icon image from OS managed resources, otherwise, in step 230, the application supplies an overlay icon image from application managed resources. Next in step 235, the OS constructs an updated icon and in step 240 the OS replaces the current icon (a desktop icon, a task button icon, or both) with the updated icon. The updated icon is a normal icon, an overlay icon on top of the normal icon or a new construct icon combining of both the normal icon image and the overlay icon image. The method then proceeds to step 245 of FIG. 7B.

Turning to FIG. 7B, in step 245 the application continually monitors itself for a change of state. When a change of state is detected, the method proceeds to step 250. In step 250, it is determined if user action is required. If user action is required then the method proceeds to step 255 where the application is put into a wait for user action mode and in step 260 the application continually monitors itself for user action. Then, when user action occurs, in step 265, the application undergoes the state transition and the method proceeds to step 270. Returning to step 250, if the transition requires no user action then the method proceeds directly to step 270. In step 270 if the transition is to normal mode then the method proceeds to step 275, otherwise the method proceeds to step 215 of FIG. 7A.

In step 275, the application notifies the OS to replace the current icon with the normal icon and in step 280 the OS restores the normal icon. Next in step 285, it is determined if the application is to terminate (either with or without user input). If the application is to terminate, then in step 290 the application is terminated and any task buttons removed from the task bar. Otherwise the method proceeds to step 205 of FIG. 7A.

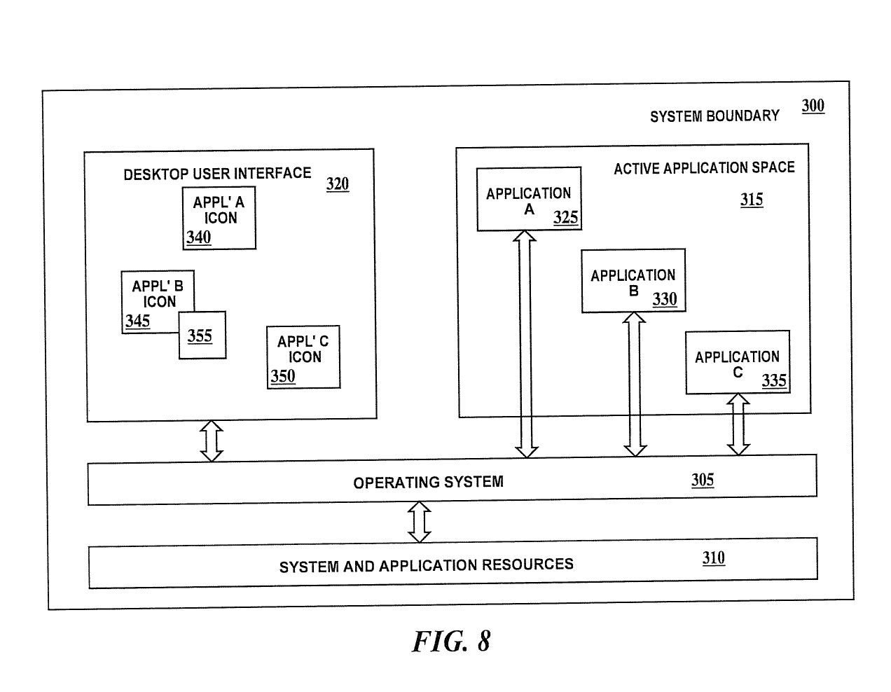

FIG. 8 is a system diagram for implementing the method of user notification of a state transition of an out-of-focus application according to embodiments of the present invention. In FIG. 8, a system boundary 300 includes an OS 305, system and application resources 310, active application space 315 and a desktop user interface 320. Active application space 315 includes exemplary applications 325, 330 and 335. Application 325 is in-focus and applications 330 and 335 are out-of-focus. Application 330 in a non-normal state and application 350 is in a normal state. Desktop user interface 320 includes icons 340, 345 and 350. Icons 340, 345 and 350 are associated respectively with applications 325, 330 and 335. Icon 345 includes and overlay icon 355.

Applications 325, 330 and 335 interface with OS 305. OS 305 interfaces with system and application resources 310 and desktop user interface 320. Non-normal icon images and overlay icon images for applications 325, 330 and 335 are passed to system and application resources 310 through OS 305. When icons 340, 345 and 350 are to be constructed as well as overlay icons such as 355, the icon image resources are retrieved from system and application resources 310 by the OS and the icons constructed in desktop user interface 320 by the OS.

Generally, the method described herein with respect to user notification of a state transition of an out-of-focus application is practiced with a general-purpose computer and the method may be coded as a set of instructions on removable or hard media for use by the general-purpose computer.

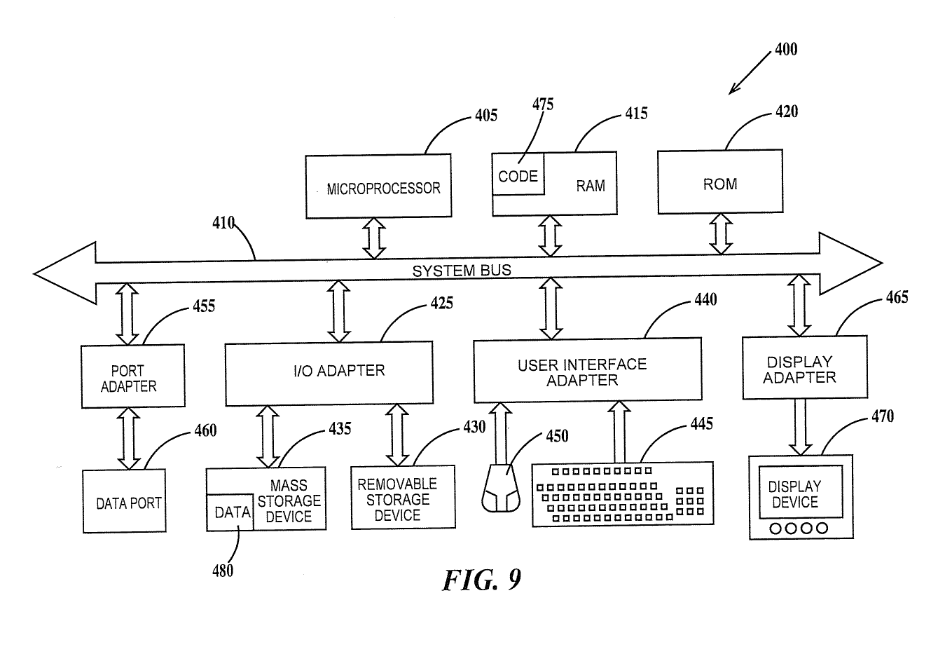

FIG. 9 is a schematic block diagram of a general-purpose computer for practicing the embodiments of the present invention. In FIG. 9, computer system 400 has at least one microprocessor or central processing unit (CPU) 405. CPU 405 is interconnected via a system bus 410 to a dynamic random access memory (DRAM) device 415 and a read-only memory (ROM) device 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

Either of devices 415 and 420 includes contains the basic operating system for computer system 400. Removable data and/or program storage device 430 may be a magnetic media such as a floppy drive, a tape drive or a removable hard disk drive or optical media such as CD ROM or a digital video disc (DVD) or solid state memory such as ROM or DRAM or flash memory. Mass data and/or program storage device 435 may be a hard disk drive or an optical drive. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

One of devices 415, 420, 430 or 435 includes a computer code 475 (illustrated by way of example in device 415), which is a computer program that comprises computer-executable instructions. Computer code 475 includes an algorithm for notification of a user of a state transition of an out-of-focus software application (e.g. the algorithm of FIGS. 7A and 7B). CPU 405 executes computer code 475. Any of devices 415, 420, 430 or 435 may include input data 480 (illustrated by way of example in device 435) required by computer code 475. Display device 470 displays output from computer code 475.

Any or all of devices 415, 420, 430 and 435 (or one or more additional memory devices not shown in FIG. 9) may be used as a computer usable medium (or a computer readable medium or a program storage device) having a computer readable program embodied therein and/or having other data stored therein, wherein the computer readable program comprises computer code 475. Generally, a computer program product (or, alternatively, an article of manufacture) of the computer system 400 may comprise said computer usable medium (or said program storage device).

Further embodiments of the present invention described infra provide a capability for a user to control how application state transitions are handled. The user can configure the specific notification type or can configure rules to evaluate state change and select a specific notification type. Table I lists various states that an Application may be in.

TABLE I

| STATE | MEANING |
|---|---|
| Normal | The application is Idle |
| Processing | The application is performing a task such |
| | as a calculation, a search, downloading or |
| | uploading from or to a server, retrieving |
| | or storing information and other tasks the |
| | application was designed to perform. |
| Error | An error has occurred and user attention is |
| | needed. |
| Warning | A warning has occurred and user attention |
| | is required. |
| Information | Information is available for the user. |
| Input Required | Either input or some action is required |
| | from the user for the application to |
| | continue. |
| Application Defined | Specified by the application |

Normal, Processing, Warning, Information, Input Required and Error are states that are generic to all applications. Application Defined states are specific to each application.

When an application is out of focus and a transition of state (ST) occurs, the user needs to be notified. The user can determine how important a particular state transition is and what notification or action to take by specifying a notification priority (NP), which has a corresponding action associated with it. Table II lists an exemplary set of notification priorities and actions.

TABLE II

| NP | Action |
|---|---|
| Urgent | Interrupt the user by bringing the |
| | application in-focus or displaying a |
| | message box. |
| Normal | Wait a pre-defined duration of time before |
| | bringing the application in-focus or |
| | displaying a message box. |
| Low | Do not interrupt the user until this state |
| | transition has occurred a pre-defined |
| | number of times. Then bring the |
| | application in-focus or display a message |
| | box. |
| Passive | Do not interrupt the user. Change a display |
| | icon, display an overlay icon over the |
| | current icon, or change an overlay icon. |
| None | Ignore and do not change the display mode |
| | of the application. |
| Other | User defined notification action. |

Additionally, the user may define rules to determine what notification priority to use when a state transition occurs. For example, in an email application, when new mail arrives, the user may wish to be notified immediately (NP=Urgent) if the email has been marked “High Priority.” In another example, if certain web-sites are slow to respond or do not respond, the user may wish to be notified after waiting a predetermined duration of time (NP=Normal). The rules query the events (state transition and environment) and determine the notification priority. In the email example above the following rule could be defined:
If email is marked High Importance,
Then NP=Urgent
Else Np=Passive

It should be noted that rules are restricted so as to result in the selection of a notification priority, but the user can generate new notification priorities and associated actions. Thus notification priorities may be considered rules that automatically select one notification priority.

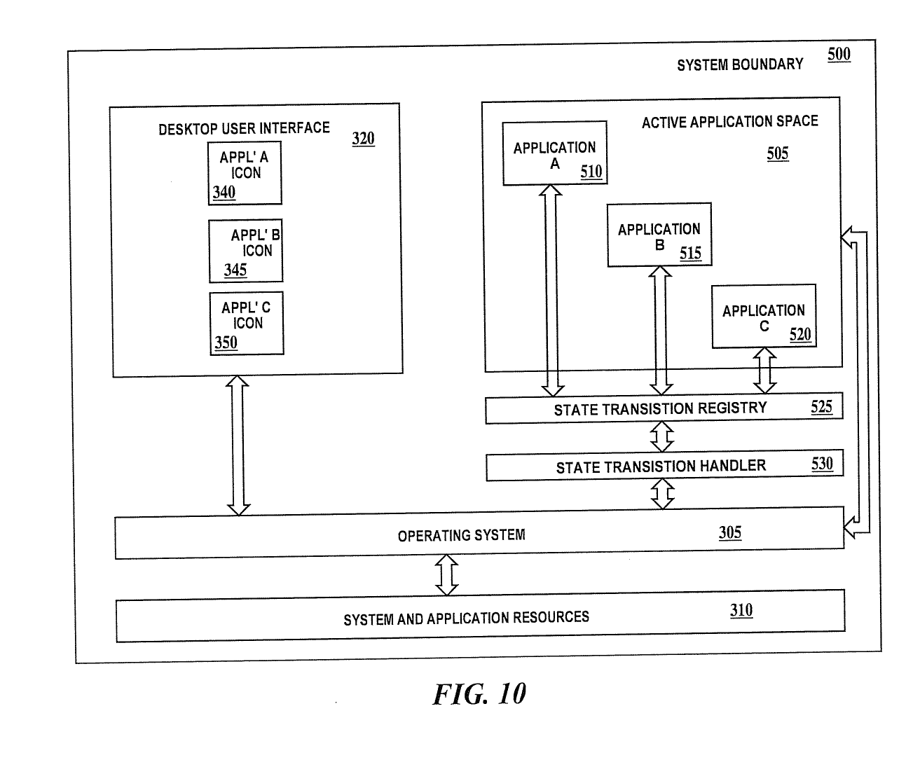

FIG. 10 is a system diagram for implementing the method of user notification of a state transition of an out-of-focus application according to further embodiments of the present invention. In FIG. 10, a system boundary 500 is similar to system boundary 300 of FIG. 8 except active application space 315 is replaced with an active application space 505, applications 325, 330 and 335 are replaced with applications 510, 515 and 520 respectively and active application space 505 further includes a state transition registry 525 and a state transition handler 530. Also applications 325, 330 and 335 are connected to state transition registry 525 rather than operating system 305 as in FIG. 8. State transition handler 530 connects state transition registry 525 to operating system 305 and there is a secondary path between active application space 505 and operating system 305.

In FIG. 10, Application 510 is in focus, and applications 515 and 520 are out of focus. Each of applications 510, 515 and 520 has a corresponding application icon 340, 345 and 350 on desktop user interface 320. Applications 510, 515 and 520 are registered with state transitions registry 525. State transitions registry 525 maintains a list of possible states applications 510, 515 and 520 can be in. In one example, an application registers with the state transitions registry 525 when it is started for the first time. State transitions registry 525 also maintains state transitions configured by the user and the corresponding notification priorities or rules to be evaluated. When a pre-configured state transition occurs, state transitions registry 525 obtains the notification priority and delegates its handling to state transition handler 530. State transition handler 530 includes logic that either has a hardware module, a software module, or a combination of both to count the pre-defined unit of time for normal notification priorities and to count the number of times a particular state transition has occurred for low notification priorities and uses operating system 305 to process the notification priority.

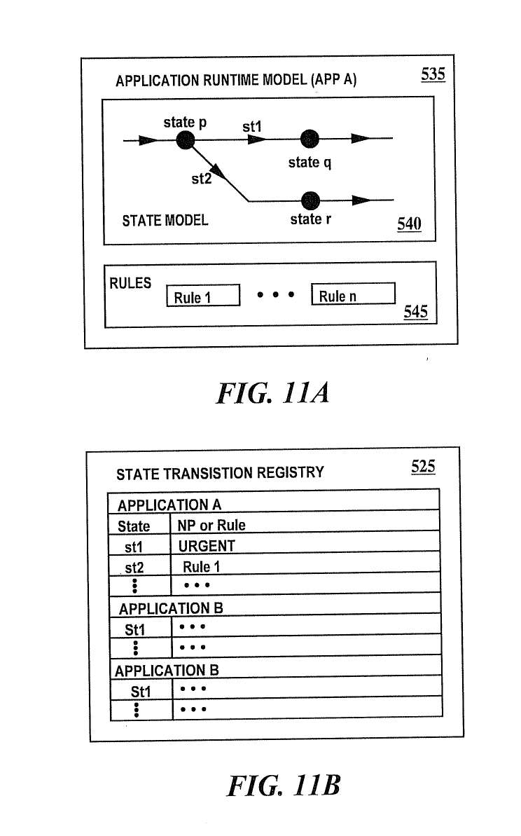

FIG. 11A is a schematic diagram of a portion of application 510 of FIG. 10 and FIG. 11B is a detailed diagram of the state transition registry of FIG. 10. according to embodiments of the present invention. In FIG. 11A, an application runtime model 535 includes a state model 540 and rules 545. Only a portion of the state model of application 510 (see FIG. 10) is illustrated in FIG. 11A. State model 540 shows there are two state transitions, st1 between state p and state q and st2 between state p and state r. It can be seen in FIG. 11B, that state transition st1 is associated with a notification priority URGENT, while state transition st2 is associated with a rule 1. In the case of st1, the notification priority is URGENT. Thus the user is interrupted when the application goes from state-p to state-q (see Table II). In the case of st2, a Rule 1 that is supplied by the application needs to be executed. The application executes Rule 1, and the rule outputs the notification priority to state transition registry 525 (see FIG. 10), which then informs state transition handler 530 (see FIG. 10) to process the notification priority. State transitions can be configured based on the ending state, the starting state or both the starting and ending states. In one example, the NP could always be URGENT if the ending state is an error state.

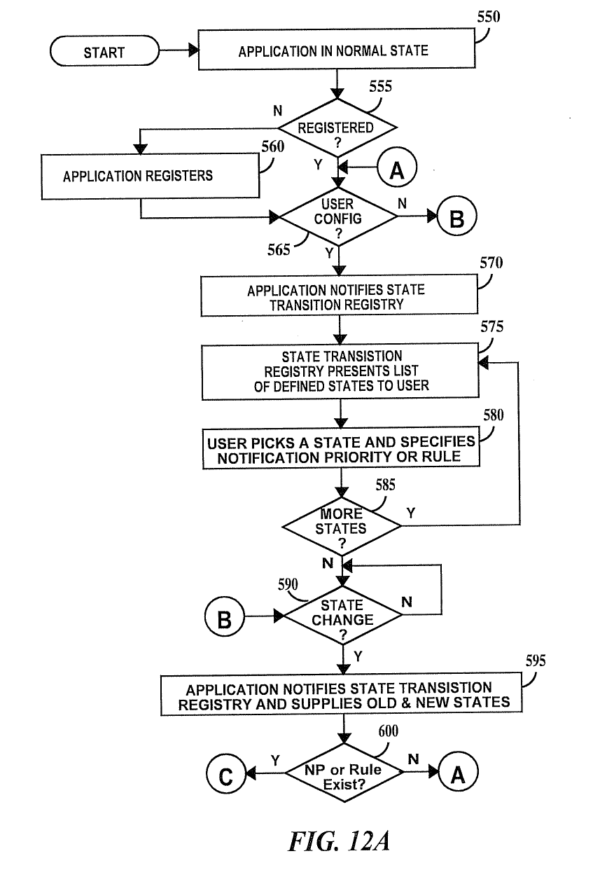

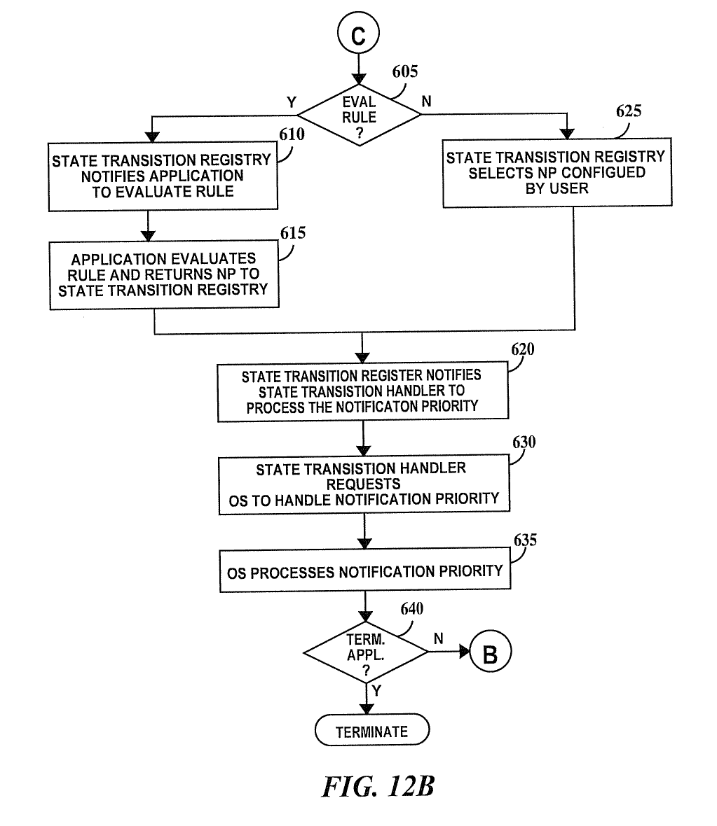

FIGS. 12A and 12B flowcharts illustrating the method of user notification of a state transition of an out-of-focus application according to further embodiments of the present invention. Referring to FIG. 12A, in step 550, the application enters the normal (or idle) state and is placed in out of focus mode by the user. In step 555, it is determined if the application is registered with the state transition registry. If the application is registered then the method proceeds to step 565. If the application is not registered, then in step 560 the application registers and the application supplies a list of defined state transitions and defined rules to the state transition registry and the method proceeds to step 565. Next, in step 565 if the user requests configuration of state transition notifications (which is automatic with the first time an application registers) then steps 570. 575, 580 and 585 are executed in sequence, otherwise the method proceeds to step 590 via connector B. In step 570, the application notifies the state transition register that the user wants to configure the state transition registry and in step 575, the state transition registry presents the list of defined states to the user. Next, in step 580, the user selects a state transition and assigns a notification priority or a rule to that state. In step 585, if more state transitions are to be configured, then the method loops to step 575, otherwise the method proceeds to step 590. In step 590 the state transition registry continually monitors the application for a change of state. If there is a change of state of the application then in step 595 the state transition registry examines the old and new states supplied by the application upon the state transition and in step 600 the state transition registry determines if a notification priority or rule is configured for that state transition. If no notification priority or rule is configured the method loops back to step 565 via connector A, otherwise the method proceeds to step 605 of FIG. 12B via connector C. Alternatively, instead of looping back to step 565, a default notification priority may be selected by the state transition registry and the method then proceeds to step 605.

Referring to FIG. 12B, in step 605 if a rule is to be evaluated then the method proceeds to step 610. In step 610 the state transition registry notifies the application to evaluate the rule and in step 612, the application evaluates the rule and returns the resulting notification priority to the state transition registry and the method proceeds to step 620. Returning to step 605, in step 605 if a rule is not to be evaluated (then there must be a notification priority) so the state transition registry selects the notification priority previously selected by the user for the current state transition and the method proceeds to step 620. Then, in step 620, the state transition registry notifies the state transition handler to process the notification priority, in step 630, the state transition handler requests the operating system to process the priority notification, and in step 635 the operating system processes the priority notification. The change in screen display as a result of the operating system processing a notification priority have been discussed supra. In step 640, it is determined if the application is to be terminated. If the application is to be terminated than the method ends, otherwise the method proceeds to step 590 of FIG. 12A via connector B.

The condition can occur, when multiple applications running, of two or more applications changing to states having the same notification priority, so it is unclear which application will take precedence. Notification priority precedence is discussed infra.

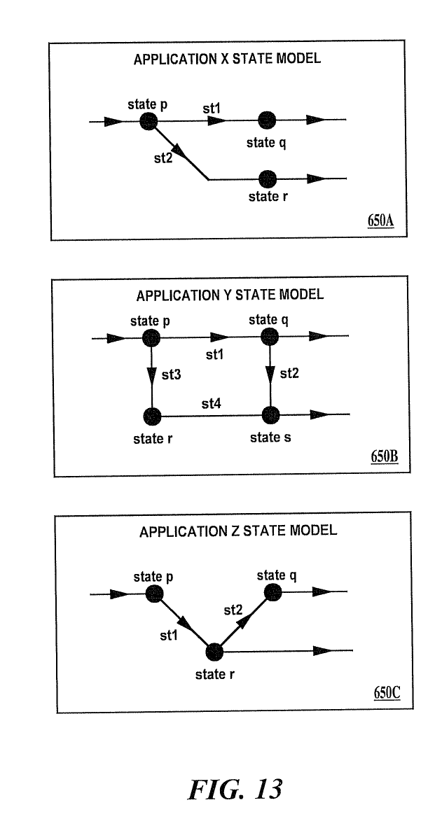

FIG. 13 illustrates state transition diagrams for exemplary applications X, Y and Z having common notification priorities according to embodiments of the present invention. Application X has an application state model a portion of which is 650A. Application X has the three states p, q and r, with a first state transition st1 between states p and q and a second state transition st2 between states p and r. Application Y has an application state model a portion of which is 650B. Application Y has the four states p, q, r and s, with a first state transition st1 between states p and q, a second state transition st2 between states q and s, a third state transition st3 between states p and r and a fourth state transition between states r and s. Application Z has an application state model a portion of which is 650C. Application Z has the three states p, q and r, with a first state transition st1 between states p and r and a second state transition st2 between states r and q. The states labeled p, q, r and s of the applications X, Y and Z are not necessarily the same states. The states transitions labeled st1, st2, st3 and st4 of the applications X, Y and Z are not necessarily the same state transitions or are associated to the same notification priority. The state transitions and associated notification priorities for applications X, Y and Z are given in TABLE III.

TABLE III

| | State | Notification |
|---|---|---|
| Application | Transition | Priority |
| X | st1 | Urgent |
| X | st2 | Low |
| Y | st1 | Urgent |
| Y | st2 | Passive |
| Y | st3 | Normal |
| Y | st4 | Low |
| Z | st1 | Low |
| Z | st2 | Urgent |

It can be seen from TABLE III that applicants X, Y, and Z each have an “Urgent” notification priority and each have a “Low” notification priority.

The situation of deciding which of applications X, Y, and Z should have precedence is resolved by creating TABLE IV (in the state transition registry) and applying the actions of the particular notification priority in the precedence order listed from a highest (column labeled 1) to a lowest (column labeled 3). The number of columns is determined by the number of applications having a common notification priority.

TABLE IV

| Notification Priority | 1 | 2 | 3 |
|---|---|---|---|
| Urgent | APP Y | APP Z | APP X |
| Normal | APP Y | | |
| Low | APP X | APP Y | APP Z |

If, for example, both application Y and Z were to transition to states (states q and q respectively, see FIG. 13) having the notification priority of URGENT, the action associated with an Urgent Notification Priority of bringing the application in focus or displaying a message box (see Table II) would be executed for application Y but not for Application Z. However if application Y were to transition from state q to state s (see FIG. 13 and Table III) and application Z remained in state q, then application Y would go out-of-focus or its message box close and application Z would go in-focus or a message box for application Z would be displayed. In more general terms, for a given notification priority, once a displayed application completes processing, that application would no longer be displayed and the application having the next highest precedence of the given notification priority would be displayed. This process would repeat until there were no more applications of the given notification priority.

The situation becomes more complicated when the notification priority is “Other” (see Table II) and the action is based on a rule. Table V is a modified version of Table III with state transition st2 having a Rule 1 notification priority that could evaluate URGENT or NORMAL. Table VI shows how the state transition registry table would deal with this situation.

TABLE V

| | State | Notification |
|---|---|---|
| Application | Transition | Priority |
| X | st1 | Urgent |
| X | st2 | Low |
| Y | st1 | Urgent |
| Y | st2 | Other (Rule 1) |
| Y | st3 | Normal |
| Y | st4 | Low |
| Z | st1 | Low |
| Z | st2 | Urgent |

TABLE VI

| Notification | | | | |
|---|---|---|---|---|
| Priority | 1 | 2 | 3 | 4 |
| Urgent | APP Y | APP Y | APP Z | APP X |
| | | If Rule 1 = Urgent | | |
| Normal | APP Y | APP Y | | |
| | | If rule 1 = Normal | | |
| Low | APP X | APP Y | APP Z | APP Y |
| | | | | If rule 1 = Low |

It can be seen that an evaluation outcome for Rule 1 is entered for each of notification priorities Urgent, Normal and Low. In Table VI, the rule evaluation cell need not be adjacent to the cell of the same notification priority that results directly. For example, in the Urgent row, APP Y and APP Y Rule 1 are adjacent, but in the Low row, APP Y is not adjacent to APP Y Rule 1, but APP Z intervenes.

Notification priorities have rankings (by row) from a highest ranking (i.e., Urgent) to a lowest ranking (i.e., Low), the ranking of Normal being between that of Urgent and Low. In determining which application is to be in-focus, first the notification priority ranking is applied and then the application precedence order within the notification priorities. For example, if a first application is in-focus and has a notification priority of Normal and a second application undergoes a state transition with a notification priority of Urgent, then the first application goes out-of-focus and the second application goes in-focus.

It should be understood a new application always starts in-focus and after starting, the focus and display mode of new application will be controlled by the last state transition of the newly started application.

Only Urgent, Normal and Low are listed in Tables IV and VI. Urgent, Normal and Low interrupt the user and change focus or present a message box. The notification priority of “None” does not change the display mode and so does not need to be addressed. The notification priority of “Passive” changes icons, which in the case of precedence is not a display mode of interest so it not included in Table IV. The notification priority of “Other” is discussed supra.

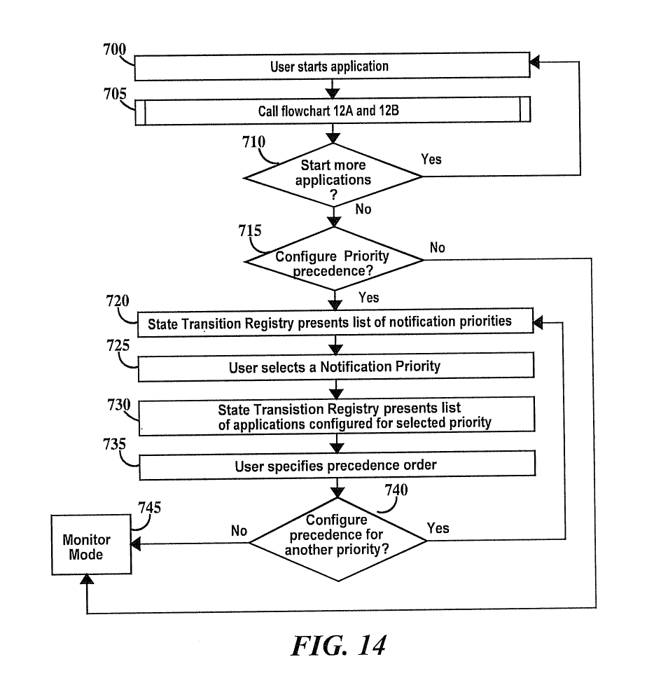

FIG. 14 is a flowchart illustrating a method of priority notification precedence according to embodiments of the present invention. In step 700, a user starts an application. In step 705 the process illustrated in FIGS. 12A and 12B and described supra are called as a sub-routine. In step 710, if more applications are to be started the method loops back to step 700 otherwise the method proceeds to step 715. In step 715, it is determined if an application notification precedence is to be configured. If precedence is to be configured then the method proceeds to step 720, otherwise to step 745.

In step 720, the State Transition Registry presents a list of available notification priorities. In step 725, the user selects a notification priority from the list of available notification priorities. In step 730, the State Transition Registry presents a list of all applications configured for the selected notification priority and in step 735, the user specifies the application precedence order for the applications.

In step 740, it is determined if precedence for another notification priority of the selected application is to be configured. If yes the method loops back to step 720, otherwise the method proceeds to step 745 where a monitoring mode is established to monitor activity in steps 710, 715 and 740.

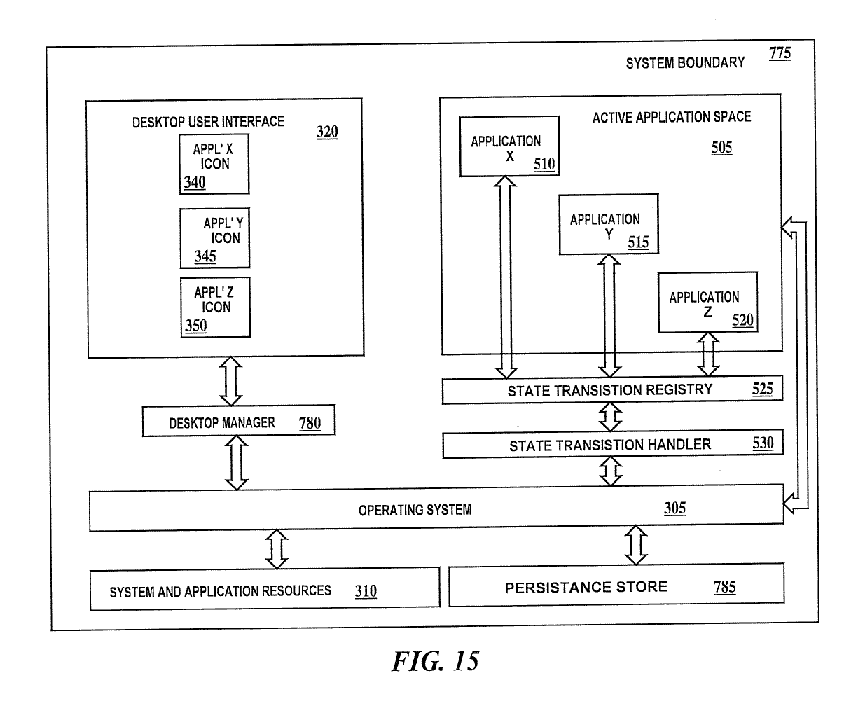

FIG. 15 is a system diagram for implementing the method of user notification precedence of a state transition of an out-of-focus application according to further embodiments of the and for application state and notification priority filtering according to embodiments of present invention. In FIG. 15, a system boundary 775 is similar to system boundary 500 of FIG. 10 except for the addition of a desktop manager 780 between operating system 305 and desktop user interface 320 and the addition of a persistence store 785 connected to operating system 305. Desktop manager 780 handles all display requests from the user and persistence store 785 remembers display settings.

Thus the present invention discloses a process for supporting computer infrastructure, integrating, hosting, maintaining, and deploying computer-readable code into a computer system, wherein the code in combination with the computer system is capable of performing a method for user notification of a state transition of an out-of-focus application with as well as providing a method of priority notification precedence.

Thus the embodiments of the present invention provide a method for applications to notify the user of an applications status or need for attention without interrupting the user and the application the user is currently working with as well as providing a method of priority notification precedence.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore it is intended that the following claims cover all such modifications and changes as fall within the true spirit and scope of the invention.

What is claimed is:

1. A method, comprising:
starting multiple applications, each application of said multiple applications having multiple possible states and having state transitions between said possible states;
starting and displaying each application of said multiple applications in respective display modes on a computer screen;
assigning a notification priority from a list of notification priorities to each state transition of each application of said multiple applications, each notification priority determining a display mode;
selecting notification priorities from said list of notification priorities;
for each selected notification priority, assigning a precedence order from high to low to those applications of said multiple applications having a same selected notification priority; and
upon state transitions of applications of said multiple applications resulting in two or more applications of said multiple applications being in a same notification priority, displaying on said computer screen, in a display mode associated with said same notification priority, only that application of said two or more applications having a higher precedence order.

2. The method of claim 1, wherein each selected notification priority is associated with performing an action, said performing said action selected from the group consisting of (i) bringing an application in-focus or displaying a message box, (ii) waiting a pre-defined duration of time before bringing a application in-focus or displaying a message box, (iii) waiting until a particular state transition has occurred a pre-defined number of times before bringing an application in-focus or displaying a message box, (iv) evaluating a rule, and (v) other user defined notification actions.

3. The method of claim 1, wherein one notification priority selected from said list of notifications priorities is associated with evaluating a rule, said rule selecting one display mode from two or more computer screen display modes.

4. The method of claim 1, wherein each state of said multiple possible states is independently selected from the group consisting of an idle state, a processing state, an error state, a warning state, an information state, an input required state and one or more application specific states.

5. The method of claim 1, further including, upon completion of processing of said application having said higher precedence order:
(a) not displaying said application having said higher precedence order;
after (a), (b) displaying on said computer screen, in a display mode associated with said same notification priority, only that application of said two or more applications having a next higher precedence order;
after (b), (c) upon completion of processing of said application having said next higher precedence order, not displaying said application on said computer screen having said next higher precedence order; and
(d) repeating steps (b) and (c) until there are no further applications being in said same notification priority.

6. The method of claim 1, further including:
ranking said notification priorities from a highest notification priority to a lowest notification priority; and
upon a first application of said multiple applications being displayed on said computer screen and a second application of said multiple applications undergoing a state transition resulting in said second application having a second notification priority having a higher ranking than a first notification priority ranking of said first application:
(a) not displaying said first application on said computer screen;
after (a), (b) displaying said second application on said computer screen in a display mode associated with said second notification priority; and
after (b), (c) upon completion of processing of said second application, not displaying said second application on said computer screen and redisplaying said first application if said second application has not changed to a state having a different notification priority from said first notification priority.

7. A computer program product, comprising a computer useable medium having a computer readable program therein, wherein the computer readable program when executed on a computer causes the computer to perform the method of:
starting multiple applications, each application of said multiple applications having multiple possible states and having state transitions between said possible states;
starting and displaying each application of said multiple applications in respective display modes on a computer screen;
assigning a notification priority from a list of notification priorities to each state transition of each application of said multiple applications, each notification priority determining a display mode;
selecting notification priorities from said list of notification priorities;
for each selected notification priority, assigning a precedence order from high to low to those applications of said multiple applications having a same selected notification priority; and
upon state transitions of applications of said multiple applications resulting in two or more applications of said multiple applications being in a same notification priority, displaying on said computer screen, in a display mode associated with said same notification priority only that application of said two or more applications having a higher precedence order.

8. The computer program product of claim 7, wherein each selected notification priority is associated with performing an action, said performing said action selected from the group consisting of (i) bringing an application in-focus or displaying a message box, (ii) waiting a pre-defined duration of time before bringing a application in-focus or displaying a message box, (iii) waiting until a particular state transition has occurred a pre-defined number of times before bringing an application in-focus or displaying a message box, (iv) evaluating a rule, and (v) other user defined notification actions.

9. The computer program product of claim 7, wherein one notification priority selected from said list of notifications priorities is associated with evaluating a rule, said rule selecting one display mode from two or more computer screen display modes.

10. The computer program product of claim 7, wherein each state of said multiple possible states is independently selected from the group consisting of an idle state, a processing state, an error state, a warning state, an information state, an input required state and one or more application specific states.

11. The computer program product of claim 7, the method further including, upon completion of processing of said application having said higher precedence order:
(a) not displaying said application having said higher precedence order;
after (a), (b) displaying on said computer screen, in a display mode associated with said same notification priority, only that application of said two or more applications having a next higher precedence order;
after (b), (c) upon completion of processing of said application having said next higher precedence order, not displaying said application on said computer screen having said next higher precedence order; and
(d) repeating steps (b) and (c) until there are no further applications being in said same notification priority.

12. The computer program product of claim 7, the method further including:
ranking said notification priorities from a highest notification priority to a lowest notification priority; and
upon a first application of said multiple applications being displayed on said computer screen and a second application of said multiple applications undergoing a state transition resulting in said second application having a second notification priority having a higher ranking than a first notification priority ranking of said first application:
(a) not displaying said first application on said computer screen;
after (a), (b) displaying said second application on said computer screen in a display mode associated with said second notification priority; and
after (b), (c) upon completion of processing of said second application, not displaying said second application on said computer screen and redisplaying said first application if said second application has not changed to a state having a different notification priority from said first notification priority.

13. A computer system comprising a processor, an address/data bus coupled to said processor, and a computer-readable memory unit coupled to communicate with said processor, said memory unit containing instructions that when executed implement a method for dynamically notifying a user of a change in state of an application running on said computer system, said method comprising the computer implemented steps of:
starting multiple applications, each application of said multiple applications having multiple possible states and having state transitions between said possible states;
starting and displaying each application of said multiple applications in respective display modes on a computer screen;
assigning a notification priority from a list of notification priorities to each state transition of each application of said multiple applications, each notification priority determining a display mode;
selecting notification priorities from said list of notification priorities;
for each selected notification priority, assigning a precedence order from high to low to those applications of said multiple applications having a same selected notification priority; and
upon state transitions of applications of said multiple applications resulting in two or more applications of said multiple applications being in a same notification priority, displaying on said computer screen, in a display mode associated with said same notification priority, only that application of said two or more applications having a higher precedence order.

14. The computer system of claim 13, wherein each selected notification priority is associated with performing an action, said performing said action selected from the group consisting of (i) bringing an application in-focus or displaying a message box, (ii) waiting a pre-defined duration of time before bringing a application in-focus or displaying a message box, (iii) waiting until a particular state transition has occurred a pre-defined number of times before bringing an application in-focus or displaying a message box, (iv) evaluating a rule, and (v) other user defined notification actions.

15. The computer system of claim 13, wherein one notification priority selected from said list of notifications priorities is associated with evaluating a rule, said rule selecting one display mode from two or more computer screen display modes.

16. The computer system of claim 13, wherein each state of said multiple possible states is independently selected from the group consisting of an idle state, a processing state, an error state, a warning state, an information state, an input required state and one or more application specific states.

17. The computer system of claim 13, the method further including, upon completion of processing of said application having said higher precedence order:
(a) not displaying said application having said higher precedence order;
after (a), (b) displaying on said computer screen, in a display mode associated with said same notification priority, only that application of said two or more applications having a next higher precedence order;
after (b), (c) upon completion of processing of said application having said next higher precedence order, not displaying said application on said computer screen having said next higher precedence order; and
(d) repeating steps (b) and (c) until there are no further applications being in said same notification priority.

18. The computer system of claim 13, the method further including:
ranking said notification priorities from a highest notification priority to a lowest notification priority; and
upon a first application of said multiple applications being displayed on said computer screen and a, second application of said multiple applications undergoing a state transition resulting in said second application having a second notification priority having a higher ranking than a first notification priority ranking of said first application:
(a) not displaying said first application on said computer screen;
after (a), (b) displaying said second application on said computer screen in a display mode associated with said second notification priority; and
after (b), (c) upon completion of processing of said second application, not displaying said second application on said computer screen and redisplaying said first application if said second application has not changed to a state having a different notification priority from said first notification priority.

19. A process for supporting computer infrastructure, said process comprising providing at least one support service for at least one of creating, integrating, hosting, maintaining, and deploying computer-readable code in a computing system, wherein the code in combination with the computing system is capable of performing a method for notification priority with precedence, the method comprising:
starting multiple applications, each application of said multiple applications having multiple possible states and having state transitions between said possible states;
starting and displaying each application of said multiple applications in respective display modes on a computer screen;
assigning a notification priority from a list of notification priorities to each state transition of each application of said multiple applications, each notification priority determining a display mode;
selecting notification priorities from said list of notification priorities;
for each selected notification priority, assigning a precedence order from high to low to those applications of said multiple applications having a same selected notification priority; and
upon state transitions of applications of said multiple applications resulting in two or more applications of said multiple applications being in a same notification priority, displaying on said computer screen, in a display mode associated with said same notification priority, repeatedly until said multiple applications have been processed, only that application of said two or more applications having a higher precedence order.

20. The process for supporting computer infrastructure of claim 19, wherein each selected notification priority is associated with performing an action, said performing said action selected from the group consisting of (i) bringing an application in-focus or displaying a message box, (ii) waiting a pre-defined duration of time before bringing a application in-focus or displaying a message box, (iii) waiting until a particular state transition has occurred a pre-defined number of times before bringing an application in-focus or displaying a message box, (iv) evaluating a rule, and (v) other user defined notification actions.

21. The process for supporting computer infrastructure of claim 19, wherein one notification priority selected from said list of notifications priorities is associated with evaluating a rule, said rule selecting one display mode from two or more computer screen display modes.

22. The process for supporting computer infrastructure of claim 19, wherein each state of said multiple possible states is independently selected from the group consisting of an idle state, a processing state, an error state, a warning state, an information state, an input required state and one or more application specific states.

23. The process for supporting computer infrastructure of claim 19, the method further including, upon completion of processing of said application having said higher precedence order:
(a) not displaying said application having said higher precedence order;
after (a), (b) displaying on said computer screen, in a display mode associated with said same notification priority, only that application of said two or more applications having a next higher precedence order;
after (b), (c) upon completion of processing of said application having said next higher precedence order, not displaying said application on said computer screen having said next higher precedence order; and
(d) repeating steps (b) and (c) until there are no further applications being in said same notification priority.

24. The process for supporting computer infrastructure of claim 19, the method further including:
ranking said notification priorities from a highest notification priority to a lowest notification priority; and
upon a first application of said multiple applications being displayed on said computer screen and a second application of said multiple applications undergoing a state transition resulting in said second application having a second notification priority having a higher ranking than a first notification priority ranking of said first application:
(a) not displaying said first application on said computer screen;
after (a), (b) displaying said second application on said computer screen in a display mode associated with said second notification priority; and
after (b), (c) upon completion of processing of said second application, not displaying said second application on said computer screen and redisplaying said first application if said second application has not changed to a state having a different notification priority from said first notification priority.
